(19) United States
(12) Patent Application Publication
(10) Pub. No.: US 2023/0116642 A1
(43) Pub. Date: Apr. 13, 2023

(54) METHOD AND APPARATUS FOR COUNTERING DDOS ATTACKS IN NDN NETWORK

(71) Applicant: ELECTRONICS AND TELECOMMUNICATIONS RESEARCH INSTITUTE, Daejeon (KR)

(72) Inventors: Dong Myung SUL, Daejeon (KR); Sung Hyuk BYUN, Daejeon (KR)

(73) Assignee: ELECTRONICS AND TELECOMMUNICATIONS RESEARCH INSTITUTE, Daejeon (KR)

(21) Appl. No.: 17/545,303

(22) Filed: Dec. 8, 2021

(30) Foreign Application Priority Data
Oct. 8, 2021 (KR) 10-2021-0134033

(51) Int. Cl. H04L 9/40

(52) U.S. Cl. CPC H04L 63/1458; H04L 63/1416; H04L 63/1425; H04L 63/20

(57) ABSTRACT

Disclosed herein is a method of checking a network attack in a named data networking (NDN) network. The method of checking a network attack according to an embodiment of the present disclosure may include checking an interest request, checking at least one of a content store (CS), a pending interest table (PIT) and a forwarding information base (FIB) and then checking data corresponding to the interest, checking a data success ratio based on at least one of the PIT and the FIB. determining a target attack path based on the data success ratio, and blocking the target attack path.

### CROSS REFERENCE TO RELATED APPLICATION

The present application claims priority to a KR application 10-2021-0134033, filed Oct. 8, 2021, the entire contents of which are incorporated herein for all purposes by this reference.

### BACKGROUND OF THE INVENTION

### Field of the Invention

The present disclosure relates to the named data networking (NDN) technology and, more particularly, to a technique of checking and processing an attack in an NDN network.

### Description of the Related Art

The main applications of the Internet have shifted from the traditional point-to-point communication to the production and delivery of massive contents, and Internet users are interested in contents, which they want, not the locations of those contents. As a response to this trend, the concept of information centric networking (ICN) has emerged which deviates from the existing host-centric communication mechanism and focuses on named information (or contents or data), and a name-based network processing method may be required to realize the concept. According to ICN, every piece of data is given a name, and communication is performed based on such names. Representative ICN projects are content centric networking (CCN) and named data networking (NDN). As CCN and NDN are rooted upon the same root and have no significant conceptual difference, they will be commonly called NDN below. In addition, such terms as “contents” and “data” will be commonly called data used in NDN.

Meanwhile, a denial of service (DoS) attack is intended to interrupt the normal service of a server. This attack paralyzes a server by sending an excessive amount of traffic that cannot be handled by the server. When a server is subject to a DDoS attack, its service is denied so that ordinary users cannot have normal access to the service. When the Internet was first designed, such security issues as DoS attacks were not considered at all.

DDoS attacks may occur in an NDN network, and thus a method of countering a DDoS attack is required.

### SUMMARY A technical object of the present disclosure is to provide a forwarder of an NDN network with a method and apparatus for countering a DDoS attack.

Another technical object of the present disclosure is to provide a method and apparatus for determining whether an inflow path of interest is a normal path or an attack path and countering an attack.

The technical objects of the present disclosure are not limited to the above-mentioned technical objects, and other technical objects that are not mentioned will be clearly understood by those skilled in the art through the following descriptions.

According to one aspect of the present disclosure, a method for checking a network attack may be provided. The method may include checking an interest request, checking at least one of a content store (CS), a pending interest table (PIT) and a forwarding information base (FIB) and then checking data corresponding to the interest, checking a data success ratio based on at least one of the PIT and the FIB, determining a target attack path based on the data success ratio, and blocking the target attack path.

The features briefly summarized above with respect to the present disclosure are merely exemplary aspects of the detailed description below of the present disclosure, and do not limit the scope of the present disclosure.

According to the present disclosure, a method and apparatus may be provided which may specify an attack path in response to an interest flooding DDoS attack in an NDN network and restrict an interest that enters through the path.

Also, according to the present disclosure, a method and apparatus may be provided which may minimize the influence of an attack by processing an interest in an NDN network, which enters through a normal path, and maintain a same processing speed as in a normal case without performance degradation.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 shows an architecture of an NDN network to which a network device is applied according to an embodiment of the present disclosure.

FIG. 2A exemplifies an operation of forwarding an interest packet in an NDN network system to which a network device is applied according to an embodiment of the present disclosure.

FIG. 2B exemplifies an operation of forwarding a data packet in an NDN network system to which a network device is applied according to an embodiment of the present disclosure.

FIG. 3A is a view exemplifying an operation of a router device provided in an NDN network system in accordance with an embodiment of the present disclosure.

FIG. 3B is a view exemplifying a PIT used in FIG. 3A.

FIG. 4 is a view exemplifying an operation of processing an interest packet in an NDN network system according to an embodiment of the present disclosure.

FIG. 5A and FIG. 5B are views exemplifying a network attack countering operation in an NDN network system in accordance with an embodiment of the present disclosure.

FIG. 6A and FIG. 6B are views exemplifying an operation of setting a counter in an NDN network system in accordance with an embodiment of the present disclosure.

FIG. 7 is a view exemplifying an operation by which a routing device controls a counter in an NDN in accordance with an embodiment of the present disclosure.

FIG. 8 is a block diagram exemplifying a computing system that implements a method of processing an interest packet in an NDN network system according to an embodiment of the present disclosure.

### DETAILED DESCRIPTION

Hereinbelow, exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure unclear. Also, portions that are not related to the present disclosure are omitted in the drawings, and like reference numerals designate like elements.

In the present disclosure, when an element is referred to as being “coupled to”, “combined with”, or “connected to” another element, it may be connected directly to, combined directly with, or coupled directly to another element or be connected to, combined directly with, or coupled to another element, having the other element intervening therebetween. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second”, etc. do not denote an order or importance. Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

Hereinafter, embodiments of the present disclosure will be described with reference to the accompanying drawings.

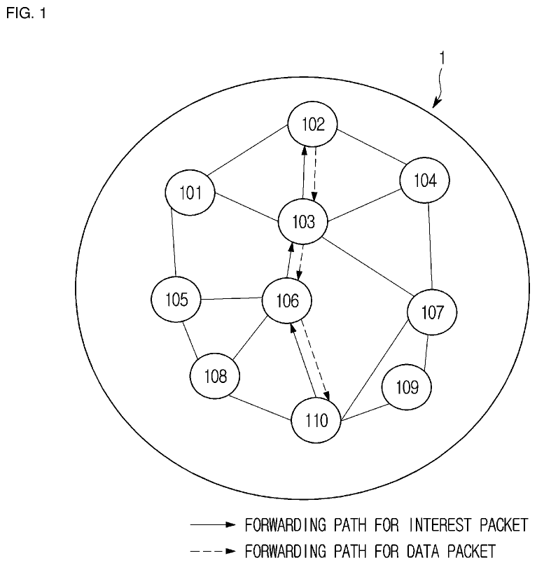

FIG. 1 shows an architecture of an NDN network to which a network device is applied according to an embodiment of the present disclosure.

In an embodiment of the present disclosure, a network 1 may include at least one node 101 to 110, and each node 101 to 110 in the network 1 may be connected to one or more other nodes. Although FIG. 1 exemplifies connections among the nodes 101 to 110 included in the network, the present disclosure is not limited thereto, and the nodes may be connected in various ways.

The network 1 may include an information centric local network, super-network or sub-network. Each of these networks may be connected with each other so that a node in a network can reach a node in another network.

The nodes 101 to 110 may include an electronic device that functions as a router device for forwarding a packet of network, a client device used or controlled by a user and a contents providing device that provides contents. Hereinafter, depending on a function of a node, “router device”, “client device” and “contents providing device” may be commonly used.

In the network 1, a second node 102 is a contents providing device that provides contents, a tenth node 110 is a client device that requests contents, a third node 103 and a sixth node 106 are router devices that forward a packet between the second node 101 and the tenth node 110.

The contents providing device 102 generates an interest packet, which includes information requesting contents demanded by a user, and the interest packet is forwarded to the contents providing device 102 through a first router device 106 and a second router device 103 that are connected to the contents providing device 102. In response to this, the contents providing device 102 may check an interest packet, detect a content demanded by a user, generate a data packet including the content and forward the data packet to the client device 110 through a reverse path of a path in which the interest packet is forwarded.

Furthermore, at least one router device included in the network 1 may forward an interest packet or a data packet, thereby participating in caching a local copy of a content.

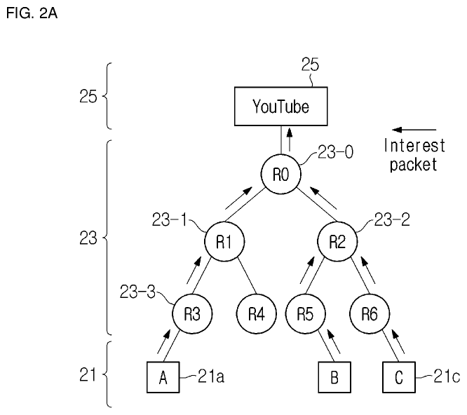

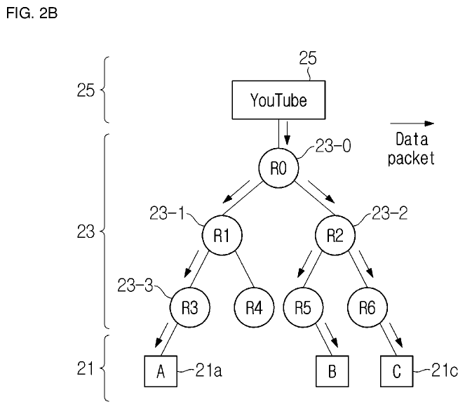

Hereinafter, referring to FIG. 2A and FIG. 2B, an operation by which a router device processes caching of contents will be described in detail.

FIG. 2A exemplifies an operation of forwarding an interest packet in a network system to which a network device is applied according to an embodiment of the present disclosure.

A client device 21 is a computing device by which a user requests a specific content, and a router device 23 is a relay device that forwards a signal or data between the client device 21 and a contents providing device 25 in an ICN system. In FIG. 2A, the contents providing device 25 is exemplified by “YouTube” that provides video streaming service. The contents providing device 25 of FIG. 2A may be a server device that provides video contents.

A user sends a content request message (Interest Packet) named by a content, which the user wants to receive through the client device 10, to the router device 23. The client device 21 forwards an interest packet for searching for a content requested by the user to a nearby router. For example, the client device A (21a) sends an interest packet to a nearby router R3 (23-3), and the router R3 (23-3) sends an interest packet to a neighboring router R1 (23-1) that is located on a path to the contents providing device 25. The router R1 (23-1) sends an interest packet to a neighboring router RO (23-0) on a path to the contents providing device 25. The router RO (23-0) sends an interest packet to the contents providing device 25. The remaining client device B (21b) and client device C (21c) send an interest packet to the contents providing device 25 in a similar way.

FIG. 2B exemplifies an operation of forwarding a data packet in a network system to which a network device is applied according to an embodiment of the present disclosure.

A path for forwarding a data packet may proceed in reverse order to a path for forwarding an interest packet. An ICN system is different from an IP-based network in that the router device 23 is configured to store certain data in its storage medium when receiving a data packet. For example, when the router R3 (23-3) receives an interest packet for a content, which has a same content name as before, from the client device A (21a), the router R3 (23-3) is configured to forward a content stored in its storage medium to the client device A (21a) without forwarding the interest packet to another router device.

For this, the router device 23 may be equipped with a content store (hereinafter referred to as CS) and a pending interest table (hereinafter referred to as PIT) for managing a CS and a forwarding information base (hereinafter referred to as FIB). In addition, the router device 23 may generate and manage an interface for communicating with another node.

Hereinafter the terms “interface” and “face” will refer to a same object and mean a path for exchanging packets with another node in a router device.

A CS stores contents (data) forwarded by the contents providing device 25, and a name of contents and data corresponding to the name of contents may be included.

A PIT may store and manage data for guiding a forwarding path of contents data. For example, a PIT may have a table containing information that indicates from which an interest packet enters, and for example, a table may contain a name of contents included in an interest packet and an interface (or face) in which the interest packet is requested. In addition, when an interest packet is forwarded to another node, a PIT may include information indicating to which interface (face) the interest packet is forwarded.

An FIB is used to forward an interest packet. An FIB functions as a routing table that determines an interface to forward a packet from a name of contents. The contents providing device 25 generates an FIB by performing a registration operation in an ICN system core.

Meanwhile, when it is assumed that the router device 23 has received an interest packet from face 1, the router device 23 checks whether or not a corresponding content is present in a CS by referring to names of contents in an interest packet first.

As the corresponding content is stored in the CS, the router device 23 returns the content to face 1 receiving the interest packet.

On the other hand, when the router device 23 receives a request of content from face 0 but the content is not stored in a CS, the router device 23 checks whether or not there is an entry stored under the same name in a PIT. In case there is an entry stored under the same name, the router device 23 discards the packet since a previously forwarded packet is received again. In case there is no entry registered by a same content name in a PIT, the router device 23 records the content name and interface and searches for the entry by performing lookup based on the content name in an FIB.

When processing search or lookup in a CS, a PIT and an FIB, the router device 23 may process the search or lookup according to longest prefix matching (LPM).

The router device 23 determines, based on information registered in an FIB, a face to which an interest packet is to be forwarded, and sends the interest packet to interface 2.

In the above-described NDN network, a normal interest is an interest enabling data to be forwarded normally according to the interest, and the structural feature of NDN described above makes it difficult to forward such a normal interest to a producer and thus to have a bad effect on the producer. An attack interest has no data according to the interest and thus always floods into a producer so that the producer cannot process a normal interest.

A general solution to address this problem is to impose a restriction based on an interest name according to a success ratio using the number of received datasets based on the number of transmissions according to a name of interest (Prefix) sent from In_Face where an interest is received. In this case, since there is an excessive number of cases according to interest names and the success ratio has a value of 0 during a latency time between reception of a normal interest and reception of normal data, which means the occurrence of a distorted value of successful reception ratio, the time to enter a step of countering DDoS is checked relatively later than the latency time.

Considering the above-described problem, in an embodiment of the present disclosure, a method for efficiently countering DDoS is proposed which calculates a success ratio of data reception not for a name but for a path at a point of receiving not interests but data, uses a method of imposing a restriction on an individual input path by calculating a success ratio of data reception for the individual input path using the path and then imposes differentiated restrictions between a normal input path and an attack input path.

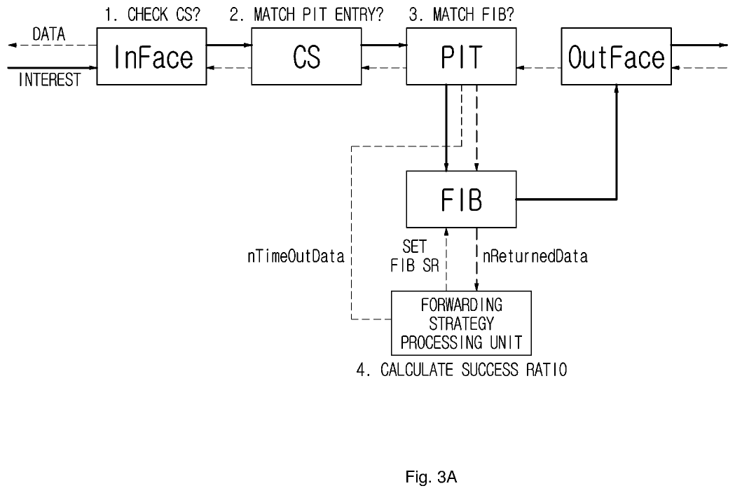

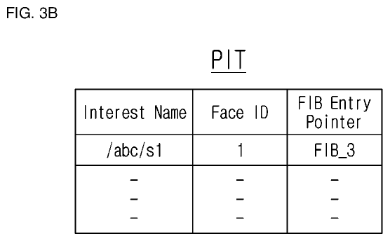

FIG. 3A is a view exemplifying an operation of a router device provided in an NDN network system in accordance with an embodiment of the present disclosure.

Referring to FIG. 3A, a router device may be configured to know FIB information from a PIT in order to calculate a data success ratio for a data request path.

The router device calculates a success ratio (SR) of a corresponding FIB in the event of data reception or PIT time-out. That is, a data success ratio is calculated by using a data reception counter (nReturnedData) and a time-out counter (nTimeOutData) that increase during a certain interval in each FIB. The router device also calculates a data success ratio for an individual InFace of the FIB by using a data reception counter and a time-out counter in the InFace. That is, the router device may calculate an SR value of an FIB entry and an SR value of each InFace(Ingress) to which an FIB belongs.

As an example, a forwarding strategy processing unit may process an operation of searching for an interest and forwarding data through a path in which the interest enters. That is, the forwarding strategy processing unit searches for a PIT suitable for an interest and increases a data reception counter (nReturnedData) for an FIB managed by the PIT. Herein, the forwarding strategy processing unit may also increase a data reception counter (nReturnedData) that is managed for each InFace of the PIT. In addition, the forwarding strategy processing unit increases a time-out counter (nTimeOutData) in the PIT, when data is not received for a specific time. Herein, the forwarding strategy processing unit increases a time-out counter (nTimeOutData) of a corresponding InFace.

Meanwhile, when data is received, the forwarding strategy processing unit calculates a success ratio (SR) for an OutFace in which the data enters and, when the SR value is lower than a threshold, sets a corresponding FIB path as a target attack path. As an example, the forwarding strategy processing unit may calculate a success ratio by using Equation 1 below.

SR=nReturnedData/(nReturnedData+nTimeOutData) [Equation 1]

Here, SR denotes a success ratio, nTimeOutData denotes a time-out counter of InFace, and nReturnedData denotes a data reception counter for FIB.

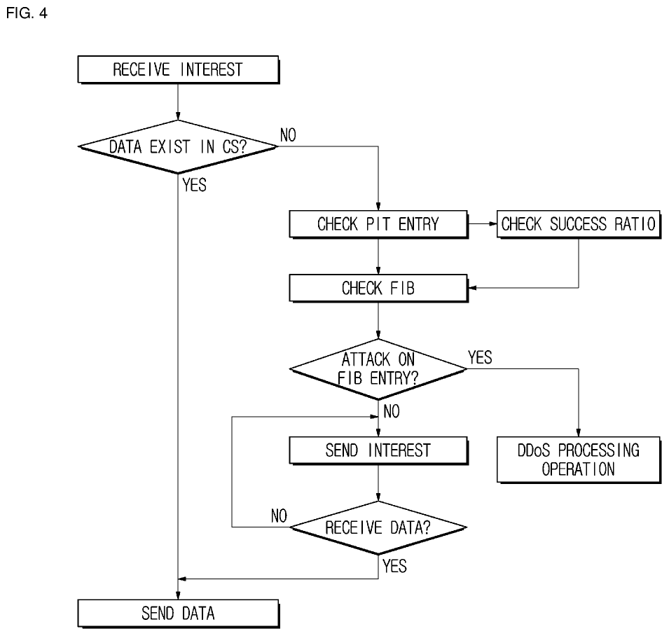

FIG. 4 is a view exemplifying an operation of processing an interest packet in an NDN network system according to an embodiment of the present disclosure.

When an interest is received, a router device checks whether or not data for a normal interest is cached in a CS. When the data is cached in the CS, the router device sends the cached data. When data is not cached in a CS, the router device may identify a path for requesting data, check whether the path is a current normal path or an attack path and then perform a corresponding operation.

As an example, by using a PIT, the router device may request data for an interest (or interest packet) and check whether or not data is received. When data is normally received, the router device may verify a normal path and perform an operation of sending the received data.

Herein, the router device may check a time-out counter (nTimeOutData) of InFace for an interest packet and a data reception counter (nReturnedData) of OutFace for a data packet. In addition, the router device may calculate a success ratio(SR) using a time-out counter (nTimeOutData) and a data reception counter (nReturnedData) and, when the SR is lower than a threshold, may set a corresponding FIB path as a target attack path.

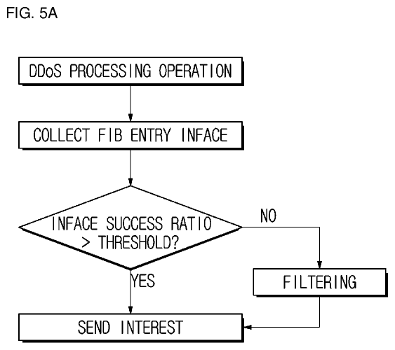

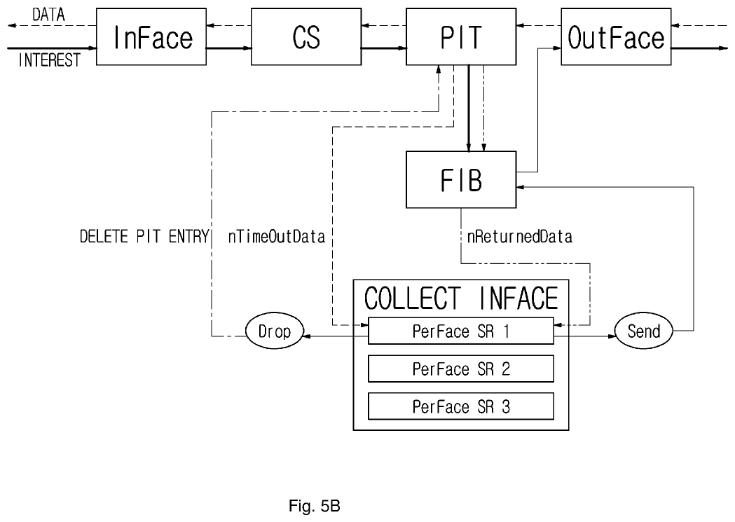

Meanwhile, in case a corresponding path is an attack path, the router device may perform an operation of countering DDoS as shown in FIG. 5A and FIG. 5B.

Management and SR calculation for individual InFaces, which are necessary for a procedure of countering DDoS, may be processed based on an FIB. For this, a normal data reception counter (nReturnedData) and a data non-reception counter (nTimeOutData) may be forwarded to an FIB and be contained and managed in the FIB.

Meanwhile, in order to quickly identify an attack path, a time for monitoring a data reception success ratio needs to be set at a short interval. As another example, when monitoring a success ratio, a result value during a previous period needs to be reflected in a next period and thus be used continuously.

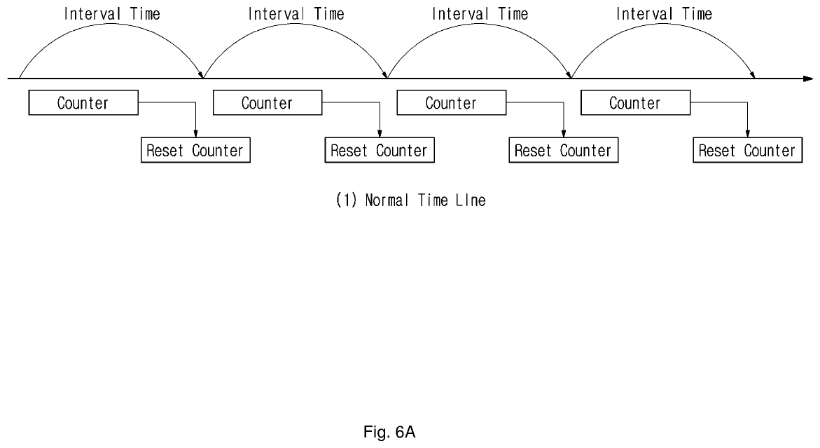

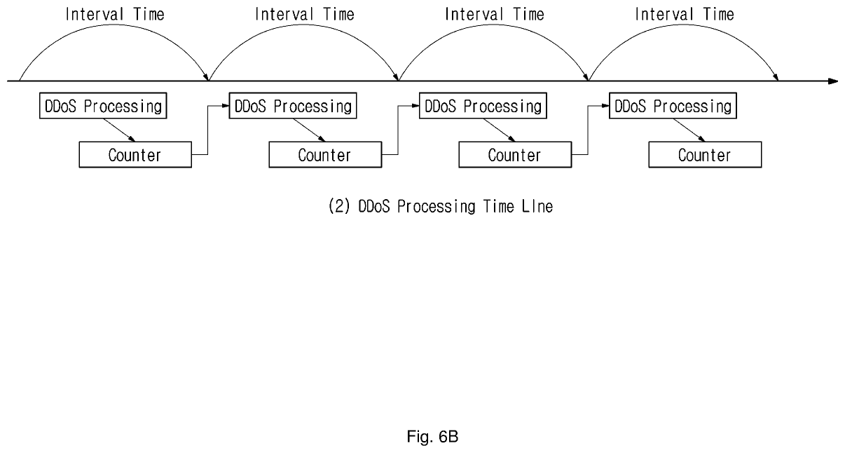

In addition, when an attack is suspended, a quick return is needed to operate a system, and a suitable monitoring time interval needs to be set accordingly. Hereinafter FIG. 6A and FIG. 6B exemplify an operation by which a router device sets a suitable monitoring time interval and processes counter information.

FIG. 6A and FIG. 6B are views exemplifying an operation of setting a counter in an NDN network system in accordance with an embodiment of the present disclosure.

Referring to FIG. 6A, when a normal interest is identified, a router device may not use a counter by continuously increasing the counter but performs counting only in a corresponding period and then initialize the counter. As an example, when an interval time is set as a unit of period and a normal interest is identified within the interval time, the router device may initialize the counter according to the interval time.

On the other hand, referring to FIG. 6B, when an interest is not identified as a normal interest, that is, when the interest is identified as a DDoS attack, the router device may set the counter so as to maintain continuity in countering DDoS. For example, in case a DDoS attack is identified, the router device may not initialize the counter, even when an interval time is reached, and may set the counter to keep counting so that the counted value can be taken successively over a next period.

Furthermore, as there may be a series of DDoS attacks, if the counted value is taken successively in a next period, the interruption of the attack may not be quickly detected, which is problematic. Considering this, the router device may preset and manage the number of periods over which the counted value is taken in succession.

Preferably, it is desirable that the router device performs initialization every second period. For example, when verifying the occurrence of a DDoS attack, the router device may check a counted value cached in the first period and set the counted value of the first period as the start value of the second period. Next, the router device may check whether or not a DDoS attack occurs in the second period and may store a counted value of the second period in the meantime. Next, when the second period ends, the router device may initialize the counter and perform a counting operation by using an initialized counting value.

Although, in an embodiment of the present disclosure, when a DDoS attack occurs, the counting initialization is performed every second period, but the present disclosure is not limited thereto, and various modifications are applicable.

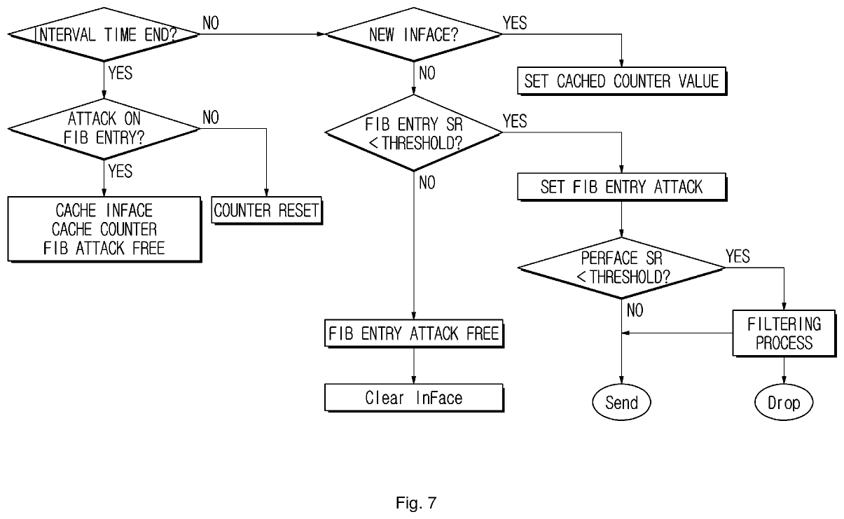

FIG. 7 is a view exemplifying an operation by which a routing device controls a counter in an NDN in accordance with an embodiment of the present disclosure.

Referring to FIG. 6A, FIG. 6B and FIG. 7, a router device may check whether or not a preset interval time is over and, when the interval time is over, may check whether or not there is an attack through an entry of FIB. When it is verified that there is an attack, the router device may store InFace and a counted value and release an attack path. On the other hand, when an entry of FIB does not undergo an attack, the router device initializes a counter.

Meanwhile, when an interval time is not over, the router device may check whether or not there is a new InFace and, when there is a new InFace, may reflect a stored counted value. When there is no new InFace, the router device may compare a success ratio for an entry of FIB with a threshold. When the success ratio for the entry of FIB is lower than the threshold, the router device may determine an attack of FIB entry and perform a procedure of countering the attack.

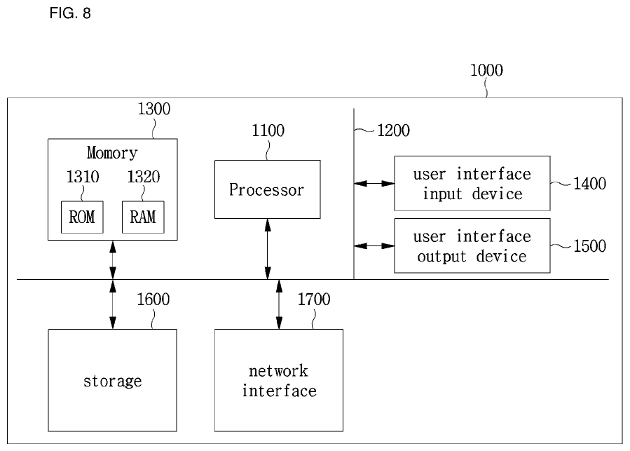

FIG. 8 is a block diagram exemplifying a computing system that implements a method of processing an interest packet in an NDN network system according to an embodiment of the present disclosure.

Referring to FIG. 8, a computing system 100 may include at least one processor 1100 connected through a bus 1200, a memory 1300, a user interface input device 1400, a user interface output device 1500, a storage 1600, and a network interface 1700.

The processor 1100 may be a central processing unit or a semiconductor device that processes commands stored in the memory 1300 and/or the storage 1600. The memory 1300 and the storage 1600 may include various volatile or nonvolatile storing media. For example, the memory 1300 may include a ROM (Read Only Memory) and a RAM (Random Access Memory).

Accordingly, the steps of the method or algorithm described in relation to the embodiments of the present disclosure may be directly implemented by a hardware module and a software module, which are operated by the processor 1100, or a combination of the modules. The software module may reside in a storing medium (that is, the memory 1300 and/or the storage 1600) such as a RAM memory, a flash memory, a ROM memory, an EPROM memory, an EEPROM memory, a register, a hard disk, a detachable disk, and a CD-ROM. The exemplary storing media are coupled to the processor 1100 and the processor 1100 can read out information from the storing media and write information on the storing media. Alternatively, the storing media may be integrated with the processor 1100. The processor and storing media may reside in an application specific integrated circuit (ASIC). The ASIC may reside in a user terminal. Alternatively, the processor and storing media may reside as individual components in a user terminal.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. A method for checking a network attack in a named data networking (NDN) network, the method comprising:
checking an interest request;
checking at least one of a content store (CS), a pending interest table (PIT) and a forwarding information base (FIB) and checking data corresponding to the interest;
checking a data success ratio based on at least one of the PIT and the FIB;
determining a target attack path based on the data success ratio; and
blocking the target attack path.

2. The method of claim 1, wherein the checking of the data success ratio comprises:
checking a data reception counter; and
checking a time-out counter.

3. The method of claim 2, wherein the checking of the data success ratio comprises calculating the data success ratio through an operation of Equation 1 below.
Success ratio=data reception counter/(data reception counter+time-out counter) [Equation 1]

4. The method of claim 1, wherein the checking of the PIT or the FIB comprises:
checking information on a data request path; and
listing the information on the data request path in the PIT.

5. The method of claim 1, wherein the determining of the target attack path comprises comparing the data success ratio with a predetermined threshold and, when the data success ratio is lower than the predetermined threshold, determining the request path as an attack path.

6. The method of claim 1, further comprising setting a counter that is a criterion for checking the success ratio.

7. The method of claim 6, wherein the setting of the counter comprises initializing the counter at every predetermined time unit.

8. The method of claim 6, wherein the setting of the counter further comprises initializing the counter at every predetermined time unit and calculating by adding a counter value, which is produced by the counter, to a counter of a next time unit, depending on whether or not the target attack path occurs.

9. The method of claim 8, wherein the setting of the counter processes a counter value produced by the counter by adding the counter value to the counter of the next time unit when the target attack path occurs.

10. The method of claim 8, wherein the setting of the counter sets a number of the predetermined time units and initializes the counter based on the number of the predetermined time units.

11. A routing apparatus provided in an NDN network system, the routing apparatus comprising:
a communication unit;
at least one storage medium; and
at least one processor,
wherein the at least one processor is configured to:
check a pending interest table (PIT) or a forwarding information base (FIB),
request a data packet based on information listed in the PIT or the FIB and check a data success ratio,
determine a target attack path based on the data success ratio, and
block the target attack path.

12. The routing apparatus of claim 11, wherein the at least one processor is further configured to:
check a data reception counter and check a time-out counter, and
determine a data success ratio by using the data reception counter and the time-out counter.

13. The routing apparatus of claim 12, wherein the at least one processor is further configured to calculate a data success ratio through an operation of Equation 2 below.
Success ratio=data reception counter/(data reception counter+time-out counter) [Equation 2]

14. The routing apparatus of claim 11, wherein the at least one processor is further configured to set a counter that is a criterion for checking the success ratio.

15. The routing apparatus of claim 14, wherein the at least one processor is further configured to initialize the counter at every predetermined time unit.

16. The routing apparatus of claim 14, wherein the at least one processor is further configured to start counting by adding a first counter value, which is counted in a first period, to a counter of a second period, when the target attack path occurs in the first period based on the predetermined time unit.

17. The routing apparatus of claim 16, wherein the at least one processor is further configured to:
set a number of the predetermined time units and
initialize the counter based on the number of the predetermined time units.
